(19) United States
(12) Patent Application Publication
(10) Pub. No.: US 2025/0049034 A1
(43) Pub. Date: Feb. 13, 2025

(54) Composition

(71) Applicant: Syngenta Crop Protection AG, Basel (CH)

(72) Inventors: Kingsley Horton Nelson, Jr., Greensboro, NC (US); Peter Michael Eure, Greensboro, NC (US)

(73) Assignee: Syngenta Crop Protection AG, Basel (CH)

(21) Appl. No.: 18/719,997

(22) PCT Filed: Dec. 1, 2021
(86) PCT No.: PCT/EP2022/084031

§ 371 Date: Jun. 14, 2024

Related U.S. Application Data
(60) Provisional application No. 63/290,929, filed on Dec. 17, 2021.

(51) Int. Cl. A01N 43/707; A01N 25/04; A01N 25/28; A01N 37/22; A01N 43/653; A01P 13/00

(52) U.S. Cl. CPC A01N 43/707; A01N 25/04; A01N 25/28; A01N 37/22; A01N 43/653; A01P 13/00

(57) ABSTRACT

A herbicidal composition comprising S-metolachlor, metribuzin and cloransulam-methyl.

### COMPOSITION

The present invention relates to compositions comprising a combination of crop protection compounds, and a method of preparing and the use of such a composition.

A variety of herbicidal compositions are known to be useful for controlling weeds of cultivated plants. Such compositions must attempt to target the weeds with minimal injury to the crops. However, common weeds have also started to develop varying levels of resistance against certain agrochemicals and composition containing a solitary herbicide can be ineffective for general application. It is a particular problem that many crops, such as soybeans, struggle against broadleaf weeds, such as ragweed.

There is therefore a need for a herbicidally active composition that is effective against a range of weeds but, in addition to control of annual grasses and small seeded broadleaf weeds, is particularly effective against large seeded broadleaf weeds. Such compositions must also demonstrate both a high level of both crop safety and physical properties, such as compositional stability.

There is therefore provided a herbicidal composition comprising S-metolachlor, metribuzin and cloransulam-methyl, which addresses the above problems. There is also herein provided the use of such a composition as a herbicide, preferably as a pre-emergent herbicide.

S-metolachlor (S-MOC) is part of the chloroacetanilide family of herbicides, used to control grasses and broad-leafed weeds, often in maize. Cloransulam-methyl is a sulfonamide used as a herbicide for the control of post-emergence control of broad-leaved weeds. Metribuzin is an herbicide used both pre- and post-emergence in crops and acts by inhibiting photosynthesis by disrupting photosystem II.

The structures of these components are shown in Table 1.

TABLE 1

| Compound | Structure |
|---|---|
| S-metolachlor | 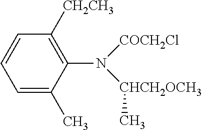 |
| Metribuzin | 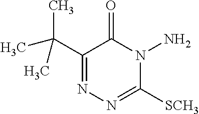 |
| Cloransulam-methyl | 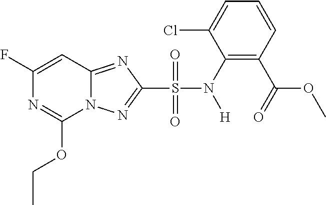 [SMILES: CCOc1nc(F)cc2nc(S(=O)(=O)Nc3c(Cl)cccc3C(=O)OC)nn12] |

Preferably the composition is a ‘ZC’ formulation comprising a stable suspension of capsules (CS) and active ingredient(s) in fluid (SC). Advantageously, the suspension of capsules (CS) comprise S-metalachlor and/or the active ingredient(s) in fluid (SC) comprise metribuzin and/or cloransulam-methyl.

The S-metalachlor may be present in an amount of from 15 to 55% by weight, such as from 20 to 50% by weight, preferably from 30 to 43% by weight, or even from 33 to 40% by weight.

The metribuzin may be present in an amount of from 1 to 20% by weight, such as from 2 to 15% by weight, preferably, from 5 to 10% by weight, or even from 6 to 8% by weight.

The cloransulam-methyl is present in amount of from 0.01 to 10% by weight, such as from 0.1 to 5% by weight, preferably from 0.4 to 1% by weight, such as from 0.5 to 0.9% by weight.

In a particularly preferred embodiment the composition comprises, from 400 to 420 g/L S-metalachlor, from 75 to 78/L metribuzin, and from 6 to 8 g/L cloransulam-methyl.

The composition preferably comprises one or more dispersing agents, more preferably the dispersing agent is selected from 2-[methyl-(1-oxo-9-octadecenyl)-amino]-ethanesulfonic acid, and/or lignins; or salts thereof.

The composition preferably comprises one or more surfactants as wetting agents and/or emulsifiers. Advantageously the one or more surfactants is/are present in an amount of from 1 to 15% by weight, such as from 2 to 14% by weight, from 3 to 12% by weight, from 4 to 10% by weight, or even from 5 to 9% by weight.

Suitable ionic surfactants are the alkali, alkaline earth and ammonium salts of aromatic sulphonic acids, for example of lignosulphonic acid, phenolsulphonic acid, naphthalenesulphonic acid, dibutylnaphthalenesulphonic acid or of fatty acids, alkyl- and alkylarylsulfonates, alkylsulphates, lauryl ether sulphates and fatty alcohol sulphates, and salts of sulphated hexa-, hepta- and octa-decanols, and of fatty alcohol glycol ethers, condensates of sulfonated naphthalene and its derivatives with formaldehyde, condensates of naphthalene or of the naphthalenesulphonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl- or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors and also proteins, denatured proteins, polysaccharides (for example methylcellulose), hydrophobically modified starches, polyvinyl alcohols (for example Mowiol®), polyalkoxylates, polyvinylamines, polyethyleneimines, polyvinylpyrrolidones and their copolymers or block polymers.

The composition preferably comprises naphthalenesulfonic acid, sodium salt condensed with formaldehyde as a wetting agent.

Advantageously, the composition comprises an ethoxylated alcohols as an emulsifier, preferably the ethoxylated alcohol has an alkyl chain of from C₂ to C₃₀, such as from C₅ to C₂₀, from C₁₀ to C₁₈, or even from C₁₂ to C₁₅. The ethoxylated alcohol may have from 5 to 30, such as from 10 to 25, preferably 20 ethoxylate monomers.

The composition may comprise an anti-foam agent, preferably polydimethylsiloxane. Advantageously, the anti-foam agent is present in an amount of from 0.001 to 0.1% by weight, such as from 0.005 to 0.015% by weight.

The composition may comprise an anti-bacterial agent, preferably 5-chloro-2-methyl-4-isothiazolin-3-one and/or 2-methyl-4-isothiazolin-3-one. Advantageously, the anti-bacterial agent is present in amount of from 0.01 to 1% by weight, such as from 0.05 to 0.15% by weight.

The composition may contain an anti-freeze agent, preferably a glycol, such as such propane-1,2-diol. Advantageously the anti-freeze agent is present in an amount of from 0.1 to 5% by weight, such as from 0.5 to 2% by weight.

The composition may contain a thickener, such as xanthan gum. Advantageously the thickener is present in an amount of from 0.01 to 1% by weight, such as from 0.05 to 0.15% by weight.

The composition may contain a preservative agent, such as 2-bromo-2-nitropropan-1,3-diol.

The compositions of the present invention may include other ingredients such as a colourant and a perfume, which are well known to the man skilled in the art.

The compositions of the present invention may include adjuvants. Examples are surfactants (e.g. non-ionic, anionic, cationic or amphoteric), wetting agents, spreading agents, sticking agents, humectants and penetration agents. Further examples of suitable adjuvants are mineral oils, vegetable oils, fatty acid esters, esters of aliphatic or aromatic dicarboxylic acids, alcohol ethoxylates, alkylphenol ethoxylates, alkylamine ethoxylates, ethoxylates of triglycerides, ethoxylates of fatty acids, ethoxylates of fatty acid esters, ethoxylates of sorbitan fatty acid esters, alkyl polyglycosides and silicone-based adjuvants. Preferred suitable adjuvants are surfactants which provide improved wetting or improved spray retention properties.

A composition as described herein may be used in the treatment of greater large seeded broadleaf (LSBL) weeds, such as common and/or giant ragweed. This use may be as part of or otherwise for the protection of soybeans.

The present invention also relates to compositions produced in a farmer's spray tank of water when a concentrate is mixed with water in the spray tank. A composition of the present invention may be in the form of a pre-mix formulation, packaged within a single vessel and ready to use directly after dilution. Thus, there is provided the use of the composition wherein such use comprises a dilution step prior to application.

The composition may be combined with at least one further active ingredient, typically a crop protection active ingredient. This further active ingredient may be in any form, such as EC, SE (suspo-emulsion concentrate) or an SL (soluble liquid).

Unless otherwise stated are percentages are given as percentages by total weight and all embodiments and preferred features may be combined in any combination.

The invention is described by the following non-limiting Examples.

### EXAMPLES

A ZC composition according to the invention (Composition 1) was prepared with the components as set out in Table 2.

TABLE 2

| | Quantity |
|---|---|
| Component | (% w/v) |
| S-metalachlor | 38.5 |
| Metribuzin | 7 |
| Cloransulam-methyl | 0.7 |
| diphenylmethane diisocyanate-based prepolymer | 3 |
| alcohols, C₁₂₋₁₅, ethoxylated derivate | 2 |
| naphthalenesulfonic acid, sodium salt condensed with | 1.5 |
| formaldehyde | |
| Propylene glycol | 1 |
| 2-[methyl-(1-oxo-9-octadecenyl)-amino]-ethanesulfonic acid | 1 |
| sodium salt | |
| lignosulfonic acid, sodium salt, sulfomethylated | 0.7 |
| lignin sulfonate sodium salt | 0.5 |
| anionic/nonionic detergent blend | 0.2 |
| Thickener | 0.1 |
| Biocide | 0.1 |
| pH buffer | 0.2 |
| Antifoam | 0.01 |
| water | remainder |

### Efficacy and Crop Safety Data

Composition 1 was tested for weed control efficacy, crop safety and effect on crop yield in a large number of trials against commercially available herbicides. The results are set out in Table 3. The application rates used were based on soil texture and the weed details are provided in points 1 to 4 below, where ‘n’ refers to the number of locations.
1. Large seeded broadleaf weed control 4 to 6 weeks after crop emergence.

Species include: Abutilon theophrasti (n=13); Ipomea sp. (n=18); Ambrosia trifida (n=7); Ambrosia artemissifolia (n=10); Xanthium strumarium (n=2); Helianthus annuus (n=1); Senna obtusifolia (n=5); Persicaria pensylvanica (n=1); Sesbania herbacea (n=3)
2. Amaranthus sp. control 4 to 6 weeks after crop emergence.

Species include: Amaranthus palmeri (n=20); Amaranthus tuberculatus (n=17); Amaranthus retroflexus (n=2); Amaranthus powellii (n=2)
3. Grass control 4 to 6 weeks after crop emergence.

Species include: Urochloa platyphylia (n=4); Digitaria sanguinalis (n=7); Dactyloctenium aegyptium (n−2); Setaria viridis (n−1); Setaria pumila (n−3); Setaria faberi (n=15); Echinocholoa crus-galli (n=6); Eleusine indica (n=1); Eriochloa villosa (n=1); Panicum dichotomiflorum (n=3); Urochloa texana (n=2)

TABLE 3

| | | | Large | | | |
|---|---|---|---|---|---|---|
| | | | Seeded | | | |
| | | Maximum | Broadleaf | | | |
| | | Crop | Weed | Amaranthus | Grass | Soybean |
| | Rate | Injury | Control¹ | sp Control² | Control³ | Yield |
| Product | (g ai/ha) | % | | | | tons/ha |
| Comp. 1 | 1740-2720 | 2.2 | 84 | 95 | 93 | 4.3 |
| Boundary ® | 1360-2180 | 1.4 | 63 | 91 | 89 | 4.1 |
| 6.5 EC | | | | | | |
| BroadAxe ® | 1170-1960 | 2.3 | 64 | 91 | 86 | 4.1 |
| XC | | | | | | |
| Sonic ® | 221-392 | 3.8 | 81 | 89 | 76 | 4.1 |
| Fierce ® | 164-230 | 10.2 | 84 | 94 | 85 | 4.1 |
| XLT | | | | | | |
| Zidua ® | 161-215 | 5.3 | 81 | 93 | 88 | 4.0 |
| Pro | | | | | | |

| | | | | | |
|---|---|---|---|---|---|
| Number of Locations | 56 | 60 | 41 | 45 | 14 |

It can be seen that the composition according to the invention provides excellent crop safety when compared to industry standards while providing comparative or improved weed control against all three weed types. These results were achieved without any negative effect on soybean yield.

This combination of broad biological efficacy with crop safety and yield is not demonstrated by existing compositions.

### Stability Data

### Physical Stability

Composition 1 was also subjected to rigorous testing of physical stability. The composition was tested for pH separation, pH, viscosity and particle size under the conditions set out in Table 4. Viscosity is given in centipoise and particle size is given in microns.

TABLE 4

| | Separation | | | | | |
|---|---|---|---|---|---|---|
| | (%) | pH | Visc. | D_{[4, 3]} | D_{(v, 0.5)} | D_{(v, 0.95)} |
| Initial | — | 7.19 | 714 | 13.5 | 8.46 | 45.1 |
| 4 wks@ RT | 1.8 | 6.87 | 722 | 14.6 | 8.41 | 55.9 |
| 4 wks@ 50° C. | 3.6 | 6.33 | 662 | 15.1 | 8.48 | 59.1 |
| 4 wks@ 38° C. | 1.8 | 6.87 | 701 | 16.0 | 8.17 | 70.7 |
| 4 wks@ 0° C. | 0 | 7.12 | 721 | 13.0 | 8.11 | 41.3 |
| 4 wks@ FT | 0 | 7.08 | 723 | 14.8 | 8.12 | 58.8 |
| 8 wks@ RT | 3.3 | 6.98 | 699 | 14.4 | 8.39 | 53.2 |
| 8 wks@ 50° C. | 8.3 | 5.87 | 635 | 15.0 | 8.46 | 60.8 |
| 8 wks@ 38° C. | 6 | 6.55 | 693 | 17.6 | 8.88 | 77.2 |
| 8 wks@ 0° C. | 0 | 6.89 | 702 | 14.0 | 8.02 | 53.1 |
| 8 wks@ FT | 1.6 | 6.44 | 792 | 14.5 | 8.13 | 55.8 |

*FT = Freeze Thaw cycle between −2° C. and 25° C. every 7 days

It can be seen that the composition of the invention is remarkably stable across a range of temperatures and times and is thus able to retain the physical properties that are optimum for both production and application.

### Chemical Stability

The stability of the active ingredients per se were also measured under a wide variation of temperature conditions. The results are set out in Table 5.

TABLE 5

| Al | Initial % wt. | 2 wks@ −18° C. | 2 wks@ 54° C. |
|---|---|---|---|
| S-metalachlor | 38.5 | 38.2 | 38.4 |
| Metribuzin | 7.2 | 7.1 | 7.1 |
| Cloransulam-methyl | 0.77 | 0.76 | 0.70 |

It can be seen that the active ingredients when part of the inventive composition exhibit negligible degradation after storage at both high and low temperatures.

The invention is defined by the claims.

1. A herbicidal composition comprising S-metolachlor, metribuzin and cloransulam-methyl.

2. The composition according to claim 1, wherein the composition is a ‘ZC’ formulation comprising a stable suspension of capsules (CS) and active ingredient(s) in fluid (SC).

3. The composition according to claim 2, wherein the suspension of capsules (CS) comprise S-metolachlor.

4. The composition according to claim 2, wherein the active ingredient(s) in fluid (SC) comprise metribuzin and/or cloransulam-methyl.

5. The composition according to claim 1, wherein the S-metolachlor is present in an amount of from 20 to 50% by weight, preferably from 30 to 40% by weight.

6. The composition according to claim 1, wherein the metribuzin is present in an amount of from 2 to 15% by weight, preferably, from 5 to 10% by weight.

7. The composition according to claim 1, wherein the cloransulam-methyl, is present in amount of from 0.1 to 5% by weight, preferably from 0.4 to 1% by weight.

8. The composition according to claim 1 comprising one or more dispersants, preferably 2-[methyl-(1-oxo-9-octadecenyl)-amino]-ethanesulfonic acid, and/or lignins; or salts thereof.

9. The composition according to claim 1 comprising one or more wetting agents, preferably naphthalenesulfonic acid, sodium salt condensed with formaldehyde.

10. The composition according to claim 1 comprising one or more emulsifiers, preferably one or more ethoxylated alcohols.

11. The composition according to claim 1 comprising one or more anti-freeze, anti-foam, thickener and/or preservative agents.

12. A method of preparing a herbicidal composition comprising combining S-metolachlor, metribuzin and cloransulam-methyl with a wetting agent comprising a naphthalenesulfonic acid, sodium salt condensed with formaldehyde.

13. (canceled)

14. (canceled)

15. (canceled)

16. (canceled)

17. A method of controlling greater large seeded broadleaf (LSBL) weeds in soybean, the method comprising applying a herbicide composition according to claim 1 to an area to be planted.

18. The method of claim 17, wherein the herbicide composition is applied pre-emergent in a soybean crop.

19. The method of claim 17, wherein the composition is diluted prior to application.

20. The method of claim 17, wherein the LSBL weeds include at least one of common ragweed and giant ragweed.
